(19) United States
(12) Patent Application Publication
(10) Pub. No.: US 2007/0300150 A1
(43) Pub. Date: Dec. 27, 2007

(54) Building rich web site applications with an embedded device

(75) Inventor: Eric Davis, Trabuco Canyon, CA (US)

Correspondence Address: Rutan & Tucker, LLP.;Hani Z. Sayed, 611 ANTON BLVD, SUITE 1400, COSTA MESA, CA, 92626, US

(73) Assignee: Lantronix, Inc.

(21) Appl. No.: 11/473,958

(22) Filed: Jun. 22, 2006

(51) Int. Cl. G06F 17/00; G06F 15/00

(52) U.S. Cl. 715/513

(57) ABSTRACT

An apparatus and a method for developing web site applications within an embedded device that may be easy to implement, debug, modify, deliver and maintain are provided. The apparatus and method remove all HTML from the embedded device firmware and utilizes web browser scripting to render the web pages properly. Removing all HTML from the embedded device firmware may allow for the creation of different and dynamic web site applications utilizing the same data served by a single compiled firmware image.

### FIELD OF THE INVENTION

The field of the invention is for an internet converter device. More specifically, the present invention relates to a system for building or modifying web site applications within a internet converter module.

### BACKGROUND OF THE INVENTION

An embedded device is a special purpose system in which a computer is usually completely encapsulated by the device it controls. An embedded device typically performs pre-defined tasks, usually with very specific requirements. The core of any embedded system is a microprocessor or controller. The microprocessor or controller is typically programmed to perform these very specific requirements. In contrast to a general purpose computer which at any time can run essentially any software application the user chooses, the software on an embedded device is semi-permanent; so it is often called firmware.

Firmware is typically defined as a computer program in a read-only memory (ROM) integrated circuit. Alternatively, firmware may be in the erasable programmable read-only memory (EPROM) chip, whose program may be modified by special external hardware, but not by [a general purpose] application program. Additionally the firmware can reside in a Flash or Non-Volatile RAM (NVRAM) chip.

Prior art embedded devices such as Ethernet converters have historically not provided wireless connectivity nor do they serve dynamic content within the embedded device. Subsequent converters, including PCMCIA cards and USB dongles, do provide wireless connectivity, but such devices are not designed for surface installation on computer or other circuit boards. In addition, the existing converters are designed for particular translations of one protocol to another or they have limited or non-existing MILARRS and other functionality. MILARRS has the following meaning: Monitoring the state of the device for an administrator; Inventory the devices sub-systems, components, or assets; Logging data or events generated by the device; Alerting an administrator of device state or taking action based on defined rules; Recovering the device if it fails or shuts down; Reporting device information or diagnostics to an administrator; and Securing the device and its assets from threats and risks. PCMCIA cards, for example, are designed to require a complex parallel interface (e.g. CARDBUS) not typically provided on non-computer products or devices. Existing wireless connectivity devices are therefore not generally suitable to OEM manufacturers for use in their products.

Traditional internet converters are known in the art, including for example, the X-Port™ from Lantronix™, which is described in the Ser. No. 10/122,867 application filed April 2002. The '867 application and other patents and patent applications cited herein are incorporated by reference in their entirety. A more recent example includes the CP/Com™ converter available from Arc Electronics™. (www.arcelect.com).

Traditionally, developing web applications that serve dynamic content within an embedded device is a time consuming process that is prone to bugs. Sending dynamic content requires the web application within the firmware image to contain HTML code that is interspersed throughout the code. For example, consider the following pseudo code that creates and sends a dynamic web page back to the browser:

Void WebAppMemoryStatsCallback(int socket){
Send(socket, “<html>”);
Send(socket, “<head></head>”);
Send(socket, “<body>”);
GetAndSendMemoryUsageStats(socket);
Send(socket, “</body>”);
Send(socket, “</html>”);}

This function creates a new web page to display the current memory usage stats and sends it back to the browser which will display it to the user.

The development process is as follows: The dynamic web application is written and then the web application is then included into the embedded device firmware sources. The embedded device firmware may then be re-compiled wherein the new compiled embedded device firmware image is then uploaded to the embedded device. The embedded device then must be rebooted to run the new firmware image. Additionally, a web browser is pointed to the web application or refreshed if already visited to view the new web application dynamic page.

There can be a complication with the pseudo code described above. Once the complication is fixed, the embedded device firmware must be re-compiled, the firmware image re-uploaded and so on in order to incorporate the fix. This re-compiling and re-uploading is a very time consuming process and is not efficient in making changes to a web application dynamic page. Additionally, assume this bug fix was against a ‘customer released’ version of the embedded device's firmware image. The new firmware image must be rolled out to all customers and, if they choose to do so, they must upload the new firmware to all of their devices and then reboot them in order for the new firmware image to take affect. Forcing a firmware upgrade and rebooting a device in the field is not a desirable situation in most cases.

Certain prior art rich media applications are known in the art. For example, U.S. Pat. No. 7,000,180 issued to Balthaser discloses a rich media application that is designed and created via the internet. A host computer is accessed from a remote user via internet connections. User account information and rich media applications are created, modified in a user account via the established internet connection. Rich-media components are added to, modified in, or deleted from scenes of a rich media application based on information contained in user requests. However, the Balthaser patent requires the system to be modified and created based on user inputs. The system does not have the ability updating and creating HTML updates and revisions thereto.

HTML interspersed within the firmware code is prone to bugs and hard to maintain. It is hard to visually see the HTML within the code and even though the data being served by the firmware code is dynamic, as laid out above, the HTML itself is not dynamic. The entire firmware image must be re-compiled and re-loaded in order to update/modify the HTML.

Thus, there is an ongoing need for an apparatus and a method for developing web site applications within an embedded device that does not require re-compiling the firmware image, and the need to continually re-upload the new firmware image and reboot the embedded device.

Moreover, a need therefore exists for an apparatus and a method for developing web site applications with an embedded device that does not require rebooting of the embedded device to run the new firmware images. Instead, only the web browser need be refreshed, and in many instances only a portion of the page need be refreshed.

### SUMMARY OF THE INVENTION

The present invention provides an apparatus and a method for an embedded device within a converter that may be modified by extracting HTML contained within the web application and put it within files on the embedded device's file system. The embedded device may then obtain data and information from a source and may use the necessary data to fill in the missing parts of the web page and/or may update or modify the web page as necessary. The output may be formatted such that it may be easily parsed by the scripting engine within the web browser. In an embodiment of the present invention, XML format is used to parse the output within the web browser.

To this end in an embodiment of the present invention a module is disclosed. The module has a file resident on a first memory, and containing a data code. The module further has a firmware image resident on a second memory, the image including a web application and a first interface that receives data. Moreover, the module has a processor functionality that associates the data with the data code, executes the web application and cooperates with software external to the module to render at least a portion of a web page in a manner that includes the data.

In another exemplary embodiment, the module has a first memory wherein the first memory comprises a RAM.

In another exemplary embodiment, the module has a first memory wherein the first memory comprises NVRAM.

In yet another exemplary embodiment, the module has a data code that has at least one HTML script.

In another exemplary embodiment, the module has a data code having at least one object that provides an asynchronous non-page refreshing data collection, and modification to the web page.

In another exemplary embodiment, the module has a second memory comprising a ROM.

In another exemplary embodiment, the module has a firmware image comprising a compiled HTTP server.

In another exemplary embodiment, the module has a firmware image devoid of HTML text.

In another exemplary embodiment, the module has a firmware image that is devoid of web browser scripting code.

In another exemplary embodiment, the module has a web application that relies upon the software including a web browser scripting functionality to render a web page.

In another exemplary embodiment, the module has a web application that relies upon the software being able to manipulate Document Object Model (DOM).

In another exemplary embodiment, the module has a first interface comprising a streaming interface.

In another exemplary embodiment, the module has a first interface comprising a streaming interface wherein the streaming interface comprises a serial interface.

In another exemplary embodiment, the module has a second interface that transmits and receives packetized information.

In another exemplary embodiment, the module has a plurality of serial interfaces and a plurality of Ethernet interfaces, and the first interface composes one of the plurality of interfaces.

In another exemplary embodiment, the module has a processor that uses the second interface to serve the web page.

In another exemplary embodiment, the module has a processor that forwards and translates information between the first interface and the second interface.

In another exemplary embodiment, the module has a processor that uses the second interface to tunnel information received from the first interface.

In another exemplary embodiment, the module has a processor functionality of a single processor.

In other exemplary embodiments, the processor functionality can comprise multiple processors, or processors with multiple cores

In an exemplary embodiment of the present invention, a method of configuring a device having a first interface that receives data in a first format, a second interface that transmits the data to a second format, a first memory storing a file, a second memory storing a firmware image of a web application, and a processor that executes the web application in a manner that transmits the data in the second format is provided. The method comprises the steps of: remotely updating the file with a plurality of scripts; and allowing the web application to serve the plurality of scripts to a remote user's web browser, which executes the scripts in a manner that displays information regarding the data. Those skilled in the art will appreciate that data can also flow in the other direction too (i.e. from the second interface to the first interface).

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: having at least one of the plurality of scripts comprising HTML.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: allowing a web browser to utilize Document Object Model (DOM).

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: generalizing the web application to use an original set of scripts contained within the file.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: removing HTML code from a previous version of the web application.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: adding HTML code to a previous version of the web application.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: modifying HTML code from a previous version of the web application.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: advertising the device as an at least one of an embedded device and an embeddable device.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: advertising that a functionality of the device can be updated without loading a new firmware image onto the device.

In another exemplary embodiment, the method for configuring a device having a first interface that receives data in a first format, a second interface that transmits the data to a second format, a first memory storing a file, a second memory storing a firmware image of a web application, and a processor that executes the web application in a manner that transmits the data in the second format is provided. The method further comprises the step of: providing a functionality of a device wherein the functionality of the device comprises at least one of a use and a configuration.

To this end, an exemplary embodiment of the present invention is for a module and method for developing web site applications within an embedded device that provides an easy utility for the implementation, debugging, and deliverance of HTML information to and from the web application.

In still yet another exemplary embodiment, a module and method for developing web site applications within an embedded device is provided wherein the module makes for easier facilitation and implementation of web site application changes wherein the module removes all HTML from the embedded device firmware and utilizes web browser scripting.

In an exemplary embodiment, the modules or embedded device utilized for building and modifying web site applications are preferably general purpose, being designed to accommodate any serial communication protocol. This includes especially 12C, CAN, ProfiBus, SPI, and USB. Similarly, modules are preferably designed to handle any suitable networking and management standards, including for example, IP, ARP, UDP, TCP, ICMP, Telnet, TFTP, AutoIP, DHCP, HTTP, and SNMP. It is especially contemplated that modules will comply with any of the 802.11x or superseding standards.

Commercial embodiments preferably include software that provide functionality other than simply protocol translation and wireless networking support. For example, the software can advantageously provide a security function such as WEP (Wired Equivalent Protocol), WPA (Wireless Networking Protected Access), SSH (Secure Shell), and SSL (Secure Sockets Layer) security protocols, and various types of encryption. Software can also provide at least one of a MILARRS functionality. In other examples, the software can provide web related services such as email alert. However, in another exemplary embodiment, the software may use AJAX scripting programming development technique for creating interactive web applications.

An antenna can be fixedly or detachably coupled to the antenna connector, and can be mounted at the module, or external to the module using a coaxial or other suitable cable. Multiple antennas are also contemplated.

The embedded device and/or modules may be used wherever a device designer wants a plug-in (or “drop-in”) system that obviates the need for independent design, development and maintenance of wireless capability. Moreover, the embedded device and/or modules may be utilized by a designer to modify and/or build rich web site applications. Examples include servers, desktop and laptop computers, and even devices such as kitchen appliances with relatively simpler electronics. It is especially contemplated that the embedded device may be used on devices having one or more rigid or flexible component boards, and can be implemented with more than one such embedded devices on a given board to provide redundancy, or to provide intra- or inter-board communication.

Additionally the modules may have memory units wherein the embedded device has a web application module that can be modified by extracting all HTML contained within the web application and put it within files on the embedded device's filesystem. The web application is then used to gather data and the resulting data is used to modify or completely re-write parts of the visible web page. The resulting output is formatted in a way that the output is parsed by the scripting engine within the web browser.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a front perspective view of a PCB board mountable converter module that uses a wired Ethernet connection.

FIG. 2 is a front view of the module of FIG. 1.

FIG. 3 is a side, partially cut-away view of the module of FIG. 1.

FIG. 4 is a schematic of the system of the present invention.

FIG. 5 is another schematic illustrating another exemplary embodiment of the present invention.

### DETAILED DESCRIPTION OF THE INVENTION

The present invention in an exemplary embodiment provides for a module and method for developing web site application within an embedded device such as a module allowing for building rich media web site applications. Rich media relates to the integration of multi-media components into content. Examples about on the Internet, including for example, Google's™ GMail™. The present invention may utilize the module and method for building or modifying rich media applications that include one or more rich media components.

It should be understood that the present invention may be a completely integrated device or in an exemplary embodiment, be a module or embedded device. As illustrated in FIGS. 1-3, module or embedded device 1 may comprise a generally rectangular housing 3. The front of the housing 3 includes an open cavity 5. A metal Faraday shield covers the top, sides and back of the housing and provides for electromagnetic-radiation (EMR) protection. The module/embedded device 1 additionally may include spring biased grounding tabs 11 that connect the Faraday shield to chassis (earth) ground by contacting the enclosure in which the connector is mounted. Also shown is an array of leads 15 for electrically interconnecting the module 1 to a printed circuit board (PCB) 17.

The cavity 5 of the housing 3 incorporates a planar array of parallel electrical contacts 19 to provide the necessary electrical contacts to form a connector port within the cavity 5. The cavity 5 is sized and dimensioned and the contacts 19 are placed within the cavity to compliment a mating plug (not shown). The sized cavity 5 along with the contacts 19 may form a standard RJ-45 connector jack. The jack contacts 19 are spring biased for engagement with a mating plug 21. An important exemplary embodiment is that novel modules as set forth herein can attach a conventional RJ-45 jack with magnetics, because the Ethernet wires are brought out of the multipin connector.

The housing 3 is formed of molded plastic or other suitable material used in the art, covered by a Faraday shield having a front wall 23, a rear wall 25, a top wall 27, a bottom wall 29, and sidewalls 31 and 33. The references herein to “top”, “bottom”, and “sides” are made for ease of explanation relative to the drawing. Alternative embodiments eliminate the plastic, and the housing material is chosen to perform the Faraday shielding function without separate components, for example by using conductive metal. It is also contemplated that the module 10 can be oriented in a multitude of ways on a product, thereby accommodating engineering requirements of specific placements.

The front wall 23 includes LEDs 35 and 37. The LEDs provide visual status and fault information for various functions of the serial-to-Ethernet conversion, such as (but not limited to) Ethernet connection speed, link present/absent, full/half duplex, Ethernet activity, serial port activity, and microcontroller error conditions.

The module/embedded device 1 web application model typically works by modifying and extracting all HTML contained within the web application 51 and putting the HTML information within files on the embedded device's filesystem 53. The device 1 then may generalize the web application code to output only the necessary data needed to fill in the missing parts of a web page (not shown) displayed to an end user (not shown). In an exemplary embodiment of the invention, the outputted data 55 may be formatted in such a way that the data 55 may be easily parsed by a scripting engine 57 within the web browser 61. In an exemplary embodiment, the scripting engine 57 within the web browser 61 may use XML. However, it should be understood, that any scripting engine 57 or suitable mark up language may be utilized to format the information sent from the device 1. For example, rewriting the traditional web application code:

```
Void WebAppMemoryStatsCallback(int socket)
{Send(socket, “<?xml version=\“1.0\”?>”);
Send(socket, “<assign>”);
Send(socket, “<id>memory_stats</id>”);
  Send(socket, “<data>”);
  GetAndSendMemoryUsageStats(socket);
  Send(socket, “</date>”);
  Send(socket, “</assign>”);}
```

The above identified function outputs basic XML which will be parsed by the scripting engine 57 running within the web browser 61. The scripting engine 57, for example Javascript, may be able to parse the XML and assign the resulting “data” to the Document Object Model (DOM). The resulting data 55 that has been parsed by XML and assigned to the DOM may be updated in the already rendered page in the web browser 61. For this example, the Javascript would look like:

```
Function MemoryStatsAssign( )
{
Var xml = GetXmlDataFromServer(“MemoryStats”);
    Var id = GetXmlData(xml, “id”);
    Var data = GetXmlData(xml, “data”);
    Document.getElementById(id).innerHTML = data;
}
```

However, it should be understood that before the Javascript and web application 51 callback may be executed, the HTML content must have been pre-loaded by the web browser 61. For this example, the HTML may look like:

<html>
<head></head>
<body onload=”MemoryStatsAssign( );”>
<h1 id=”memory_stats”></h1>
</body>
</html>

The above illustrated HTML page contains the Javascript event trigger “onload”. This event trigger “onload” is called only after the page has been fully loaded by the web browser 61. In this case the event function gets the memory data 55 from the embedded device 1 web application 51 and inserts the results in the “<h1>” tag.

As mentioned earlier, the HTML content resides on the embedded device's filesystem 53 storage. The HTML files may be modified in real time and may still be utilized as anticipated by a user and yet without the need to continuously modify the firmware image 65. For example, Customer A might modify the memory stats HTML page as follows:

```
<html>
<head>
<title>Memory Stats</title>
</head>
  <body onload=”MemoryStatsAssign( );”>
  The Current Memory Stats are: <span style=”color: red;”
  d=”memory_stats”></span>
  </body>
  </html>
```

And Customer B might modify the memory stats HTML page as follows:

<html>
<head></head>
<body onload=”MemoryStatsAssign( );”>
<div style=”border: 5px solid blue”><h2
id=”memory_stats”></h2></div>
</body>
</html>

In either case the embedded device firmware 65 is same. The memory stats function always outputs the raw XML data which is parsed and inserted into the rendered web page 61 however the HTML page is layed out. The only requirement for the data 55 to be shown is the “memory_stats” identification name must be the same in both the firmware image 65 and HTML page.

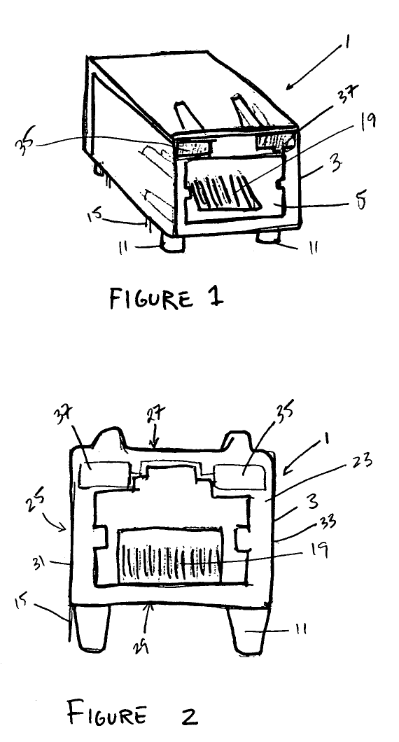

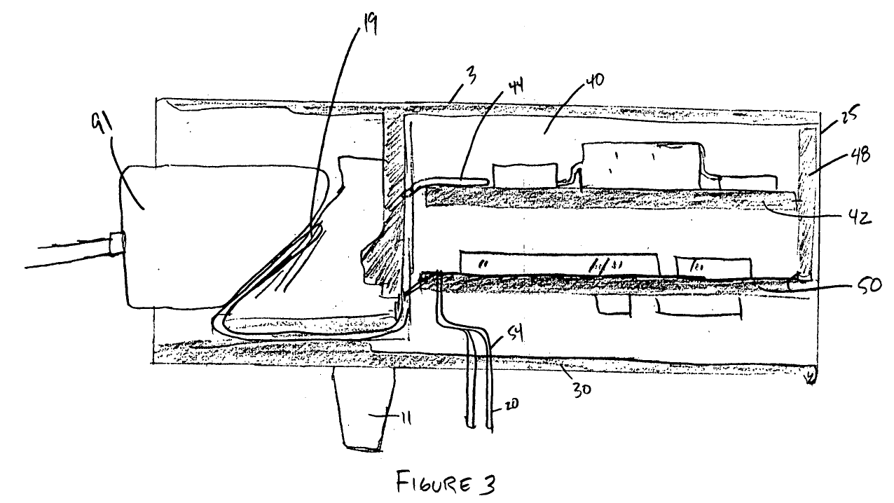

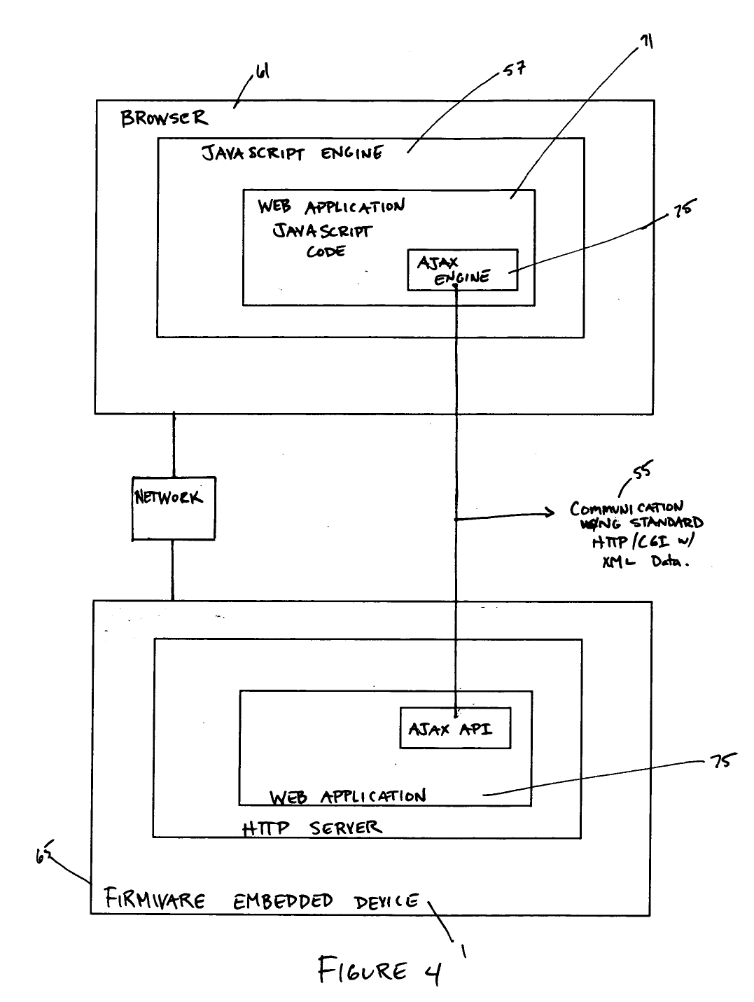

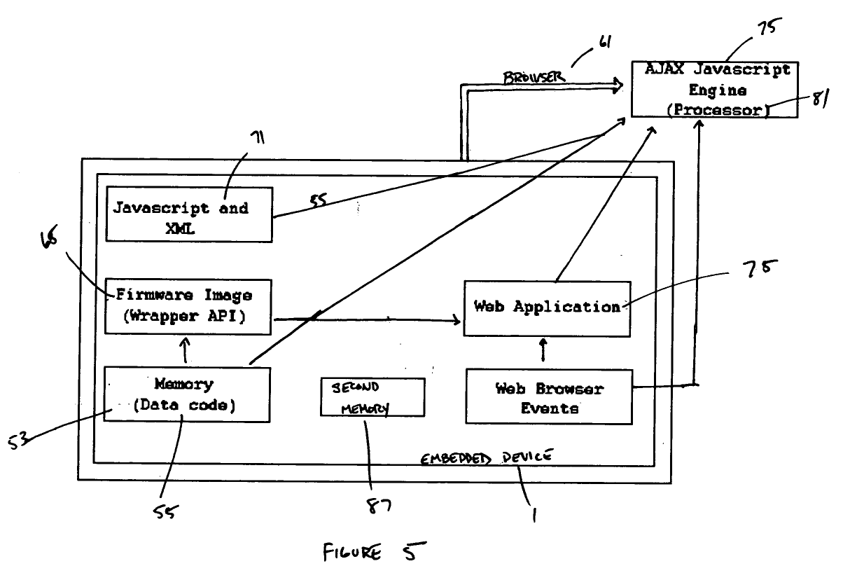

The present invention as illustrated in FIGS. 4 and 5 has the ability for multiple users of web browsers 61 to build and or modify their own web pages in a simple process. The end user may radically change the layout and navigation of the original web site but the back end web application 51 contained within the firmware image 65 does not change. This results in greater control over the development and future releases of the embedded device 1 firmware image 65.

By moving the HTML to its own files allows the use of very popular HTML editors which facilitates rapid development and modification of web pages. The more rapid development and modification of web pages may result in quicker response to changes to web pages and results in less complicated web pages since the HTML content is no longer contained within the web application code which an HTML editor is unable to parse/edit.

Additionally, by moving the HTML to its own files greatly reduces the size of the embedded devices 1 firmware image. The HTML ‘text’ is no longer contained with the firmware image thereby potentially freeing up valuable resources on the embedded device 1.

In an exemplary embodiment of the method described herein and illustrated in FIGS. 4 and 5, would be the implementation of AJAX (Asynchronous Javascript and XML) 71 within an embedded device 1. The embedded device 1 firmware image 65 may contain AJAX wrapper APIs 73 which essentially wrap outgoing data 55 in XML. These wrappers 73 will send instructions back on what to do with the data 55. These instructions can be assign/replace data, prepend data, append data, clear data, add a new HTML element, delete an existing HTML element, popup alert, and the like.

Additionally, the implementation will contain a supporting AJAX Javascript Engine 75 the runs in the web browser 61 which is able to handle (asynchronously using the Javascript XMLHttpRequest) requests to and responses from the embedded device 1 web application 51. The AJAX Javascript Engine 75 may handle web browser 61 events (i.e. mouse clicks, text entry, form submission, etc) and may perform the proper action to update the Document Object Model as needed. Any aspect of the rendered page can be changed dynamically on the fly using AJAX without refreshing the entire page.

An AJAX based web site may result in small portions of the rendered page getting updated after a web browser 61 event is triggered. The embedded device 1 web application 51 request and response is minimal utilizing less resources all around (i.e. embedded device memory, CPU cycles, and network bandwidth). The entire page is only loaded once at the beginning of the web browsing session.

FIG. 3 illustrates the housing 3 that may include a segregated interior chamber 40. A first PCB 42 is disposed within the interior chamber 40 generally horizontal and parallel relative to the bottom wall 30. The first PCB 42 is soldered (or otherwise electrically connected) to the contact interface 44, which is mounted in a plastic insert. The completed insert assembly slides and snaps into the main housing 3. The contact interface pins 44 are formed such that their ends become the wiper contacts 19. Thus, the first PCB 42 is electrically interconnected to the contacts 19 of the port cavity 5. The contact interface 44 additionally provides structural support to the first PCB 42.

A second PCB 50 is also placed within the interior chamber 40, positioned generally horizontal and in general parallel relation to the bottom wall 30. The second PCB 50 is soldered (or otherwise electrically connected) to the array of leads 54, which are formed such that their ends become the input/output pins 20 (more specifically, these pins 20 connect power and ground, reset, serial data input and output, handshake and flow control lines, and PIO lines) that connect to the user's PCB 20. The array of leads 54 are mounted in a plastic insert. After the second PCB 50 is soldered (or otherwise connected) to the leads 54, the completed insert assembly slides and snaps into the main housing 3.

A third PCB 48 is placed within the interior chamber 40 in a generally vertical orientation, and is generally perpendicular to the other PCBs 42 and 50. PCB 48 is positioned adjacent the rear wall 25 and is structurally and electrically interconnected to the other PCBs 42 and 50 by the formed pins 49 and 52. PCB 48 and formed pins 49 and 52 thus provide the electrical connection between PCBs 42 and 50. The LEDs 37 have leads (not shown) that run close to the top of the enclosure 12, and these leads also connect to holes in PCB 48. This provides the electrical connection between the LEDs 37 and the control PCB 50.

The first, 42, and second PCB 50 collectively incorporate the electronic circuitry component necessary to complete a serial-to-Ethernet conversion of data. PCB 42 includes the magnetics portion of the circuitry which can advantageously include isolation transformers, common mode chokes, termination resistors, and a high voltage discharge capacitor (for ESD and voltage surges). In this implementation, PCB 48 is used solely for electrical interconnection, but it could also be used for circuitry components if required.

PCB 50 incorporates all of the electronic circuitry components necessary for the control function of the serial-to-Ethernet conversion. The electronic components on board PCB 50 include, but are not limited to, a microprocessor and an Ethernet controller (which can advantageously be combined in an ASIC), nonvolatile memory (flash memory in the present invention), voltage regulator, voltage supervisory circuit, crystals, resistors, capacitors, and ferrite or other surface mount beads.

In operation, the complete assembly is mounted on a PCB that is a part of some device or equipment. Serial data and general purpose PIO data flows from the device through the array of leads 20 and is processed by the circuitry collectively incorporated onto PCBs 42, 48 and 50. PCB 42 is interconnected to the contacts 19 which mate with a plug 91 to effectively transmit Ethernet data thereto. Ethernet data can also flow from the Ethernet port through wiper contacts 19, be processed by the circuitry collectively incorporated onto PCBs 42, 48 and 50, and flow out as serial data and general purpose PIO data through lead pins 20 into the external device. It is additionally contemplated that the control circuitry, magnetic circuitry and LED circuitry can be interchanged among PCBs 42, 48 and 50 and that component can be positioned on one or both sides of each PCB's 42, 48 and 50.

As illustrated in FIG. 5, several components may be contained within the embedded device 1. These may include, but are not limited to, a microprocessor 81 and an Ethernet controller 83 (which may be combined with other components for the present invention), a first memory 85 having a RAM, a second memory 87 that may store an operating system, environment and that may store at least one web page and that may cooperate with software external to the embedded device 1 to modify information on a web page. Additionally, the embedded device 1 may also comprise voltage regulators, voltage supervisory circuitry, crystals, resistors, capacitors, and ferrite beads.

Thus, specific embodiments and applications of wireless communication ports have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

What is claimed is:

1. A module comprising:
a file resident on a first memory, and containing a data code;
a firmware image resident on a second memory, the image including a web application;
a first interface that receives data;
a processor functionality that associates the data with the data code, executes the web application, and cooperates with software external to the module to render at least a portion of a web page in a manner than includes the data.

2. The module of claim 1, wherein the first memory comprises a RAM.

3. The module of claim 2, wherein the first memory comprises NVRAM.

4. The module of claim 1, wherein the data code comprises at least one HTML script.

5. The module of claim 1, wherein the data code comprises at least one object that provides an asynchronous non-page refreshing data collection, and modification to the web page.

6. The module of claim 1, wherein the second memory comprises a ROM.

7. The module of claim 1, wherein the firmware image comprises a compiled HTTP server.

8. The module of claim 1, wherein the firmware image is devoid of HTML text.

9. The module of claim 1, wherein the firmware image is devoid of web browser scripting code.

10. The module of claim 1, wherein the web application relies upon the software including a web browser scripting functionality to render the web page.

11. The module of claim 10, wherein the web application relies upon the software being able to manipulate Document Object Model (DOM).

12. The module of claim 1, wherein the first interface comprises a streaming interface.

13. The module of claim 12, wherein the streaming interface comprises a serial interface.

14. The module of claim 1, further comprising a second interface that transmits and receives packetized information.

15. The module of claim 1, further comprising a plurality of serial interfaces and a plurality of Ethernet interfaces, and the first interface composes one of the pluralities of interfaces.

16. The module of claim 15, wherein the processor uses the second interface to serve the web page.

17. The module of claim 14, wherein the processor forwards and translates information between the first interface and the second interface.

18. The module of claim 14, wherein the processor uses the second interface to tunnel information received from the first interface.

19. The module of claim 1, wherein the processor functionality is a single processor.

20. The module of claim 1, wherein the processor functionality comprises multiple processors.

21. A method of configuring a device having a first interface that receives data in a first format, a second interface that transmits the data in a second format, a first memory storing a file, a second memory storing a firmware image of a web application, and a processor that executes the web application in a manner that transmits the data in the second format, comprising:
remotely updating the file with a plurality of scripts;
allowing the web application to serve the plurality of scripts to a remote user's web browser, which executes the scripts in a manner that displays information regarding the data.

22. The method of claim 21, wherein at least one of the plurality of scripts comprises HTML.

23. The method of claim 21, wherein the step of allowing comprises the web browser utilizing Document Object Model (DOM).

24. The method of claim 21, further comprising generalizing the web application to use an original set of scripts contained within the file.

25. The method of claim 21, further comprising removing HTML code from a previous version of the web application.

26. The method of claim 21, further comprising adding HTML code to a previous version of the web application.

27. The method of claim 21, further comprising modifying HTML code from a previous version of the web application.

28. The method of claim 21, further comprising advertising the device as an at least one of an embedded device and an embeddable device.

29. The method of claim 21, further comprising advertising that a functionality of the device can be updated without loading a new firmware image onto the device.

30. The method of claim 29, wherein the functionality of the device comprises at least one of a use and a configuration.
